(19) United States
(12) Patent Application Publication
(10) Pub. No.: US 2014/0308940 A1
(43) Pub. Date: Oct. 16, 2014

(54) METHOD AND APPARATUS FOR SWITCHING OPERATION MODE OF MOBILE PHONE

(71) Applicant: Samsung Electronics Co., Ltd., Gyeonggi-do (KR)

(72) Inventor: Woo-Up KWON, Seoul (KR)

(73) Assignee: Samsung Electronics Co., Ltd., Gyeonggi-do (KR)

(21) Appl. No.: 14/242,363

(22) Filed: Apr. 1, 2014

(30) Foreign Application Priority Data
Apr. 10, 2013 (KR) 10-2013-0039154

(51) Int. Cl. H04W 88/06

(52) U.S. Cl. CPC H04W 88/06
USPC 455/418

(57) ABSTRACT

A method and apparatus for setting an operation mode of a mobile terminal are provided. The apparatus includes an atmospheric pressure measuring unit measuring an atmospheric pressure at a current location of the mobile terminal; and a controller determining whether the measured atmospheric pressure is a cabin atmospheric pressure, and setting the operation mode of the mobile terminal according to the determination.

### PRIORITY

This application claims priority under 35 U.S.C. §119(a) to a Korean patent application filed on Apr. 10, 2013 in the Korean Intellectual Property Office and assigned Serial No. 10-2013-0039154, the entire content of which is incorporated herein by reference.

### BACKGROUND OF THE INVENTION

1. Field of the Invention

The present invention relates generally to a method and apparatus for switching an operation mode of a mobile terminal, and more specifically, to a method and apparatus for setting an airplane mode of the mobile terminal.

2. Description of the Related Art

Mobile terminals, such as smart phones, tablet computers, etc., provide users with various useful functions through various applications, usage of mobile terminals is becoming increasingly common.

Due to the popularization of mobile terminals, many users carry their mobile terminals with them, even when traveling by plane.

However, since waves from mobile terminals may cause jamming of electronic equipment installed in an aircraft, airlines request passengers not to use their mobile terminals in an aircraft if possible. In particular waves from mobile terminals may cause jamming of electronic equipment installed in an aircraft that may be used upon taking off or landing.

In order to prevent use of mobile terminals from affecting operation of an airplane, an “airplane mode” has been provided. If a mobile terminal is switched to an airplane mode, the mobile terminal blocks its communication functions, while allowing a user to freely use the other functions of the mobile terminal without having bad influence on operation of an airplane. However, in order to use the airplane mode, the user himself/herself must switch the mobile phone to the airplane mode when boarding an airplane, and also release the airplane mode when getting off the airplane, which may cause inconvenience to the user.

Accordingly, there is a need for a technique for automatically switching the operation mode of a mobile terminal to an airplane mode when a user possessing the mobile terminal boards an airplane, without the requiring the user to turn on/off the airplane mode, so that waves from the mobile terminal do not negatively influence operation of the airplane.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are provided to address at least the above-mentioned problems and/or disadvantages and to provide at least the advantages described below. Accordingly, an aspect of the present invention provides a method and apparatus for easily switching an operation mode of a mobile terminal to an airplane mode upon boarding an airplane so that waves from the mobile terminal have no bad influence on operation of the airplane.

According to an aspect of the present invention, a method for switching an operation mode of a mobile terminal is provided. The method includes measuring an atmospheric pressure at a current location of the mobile terminal; determining whether the measured atmospheric pressure is a cabin atmospheric pressure; and setting the operation mode of the mobile terminal according to the determination.

According to another aspect of the present invention, a method for switching an operation mode of a mobile terminal is provided. The method includes measuring an atmospheric pressure at a current location of the mobile terminal; determining whether the measured atmospheric pressure is a cabin atmospheric pressure; displaying a pop-up window for allowing a user to switch the operation mode of the mobile terminal if the measured atmospheric pressure is the cabin atmospheric pressure; determining whether to set the operation mode of the mobile terminal to an airplane mode according to whether a user command for switching the operation mode of the mobile terminal to the airplane mode is received through the pop-up window; and setting the operation mode of the mobile terminal according to the determination.

According to another aspect of the present invention, an apparatus for switching an operation mode of a mobile terminal is provided. The apparatus includes an atmospheric pressure measuring unit measuring an atmospheric pressure at a current location of the mobile terminal; and a controller determining whether the measured atmospheric pressure is a cabin atmospheric pressure, and setting the operation mode of the mobile terminal according to the determination.

### BRIEF DESCRIPTION OF THE DRAWINGS

The above and other aspects, features and advantages of certain embodiments of the present invention will be more apparent from the following description taken in conjunction with the accompanying drawings, in which:

FIG. 1 is a block diagram illustrating a mobile terminal according to an embodiment of the present invention;

FIG. 2 is a block diagram illustrating a controller according to an embodiment of the present invention;

FIG. 3 is a flowchart illustrating a method for automatically switching an operation mode of a mobile terminal to an airplane mode, according to an embodiment of the present invention;

FIG. 4 is a flowchart illustrating a method for semi-automatically switching an operation mode of a mobile terminal to an airplane mode, according to an embodiment of the present invention;

FIG. 5 is a flowchart illustrating a method for manually switching an operation mode of a mobile terminal to an airplane mode, according to an embodiment of the present invention;

FIGS. 6A and 6B illustrates the method for automatically switching an operation mode of a mobile terminal to an airplane mode, according to an embodiment of the present invention;

FIGS. 7A to 7C illustrate a method for semi-automatically switching an operation mode of a mobile terminal to an airplane mode, according to an embodiment of the present invention; and

FIGS. 8A to 8C illustrate a method for manually switching an operation mode of a mobile terminal to an airplane mode, according to an embodiment of the present invention.

### DETAILED DESCRIPTION OF EMBODIMENTS OF THE PRESENT INVENTION

The following description with reference to the accompanying drawings is provided to assist in a comprehensive understanding of embodiments of the invention as defined by the claims and their equivalents. It includes various specific details to assist in that understanding but these are to be regarded as mere examples. Accordingly, those of ordinary skill in the art will recognize that various changes and modifications of embodiments described herein can be made without departing from the scope and spirit of the invention. In addition, descriptions of well-known functions and constructions may be omitted for clarity and conciseness.

The terms and words used in the following description and claims are not limited to their dictionary meanings, but are merely used to enable a clear and consistent understanding of the invention. Accordingly, the following description of embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces. Throughout the drawings, like reference numerals will be understood to refer to like parts, components, and structures.

A mobile terminal according to an embodiment of the present invention is a portable electronic device, such as, for example, a video phone, a mobile phone, a smart phone, International Mobile Telecommunication 2000 (IMT-2000), a Wideband Code Division Multiple Access (WCDMA) terminal, a Long Term Evolution (LTE) terminal, a Long Term Evolution Advanced (LTE-Advanced) terminal, a Universal Mobile Telecommunication Service (UMTS) terminal, a Personal Digital Assistant (PDA), a Portable Multimedia Player (PMP), a Digital Multimedia Broadcasting (DMB) terminal, E-Book, laptop computer, tablet computer, or a digital camera.

An airplane mode according to an embodiment of the present invention is a mode for blocking radio signal transmission from a mobile terminal. If a mobile terminal is switched to the airplane mode, functions of making a voice or video call, sending messages, etc., based on a mobile communication network are disabled while use of applications installed in the mobile terminal is allowed.

Meanwhile, if a mobile terminal is out of a communication range or generates weak signals to connect to a mobile communication network, the mobile terminal may consume up to four times more battery power than in a normal state. This additional battery power consumption results from the mobile terminal increases the intensity of an output signal for a stable connection to the mobile communication network. Accordingly, by using a method and apparatus for switching an operation mode of a mobile terminal when a user boards an airplane, according to embodiments of the present invention, it is possible to reduce battery consumption of the mobile terminal during a flight.

Hereinafter, embodiments of the present invention will be described in detail with reference to the accompanying drawings.

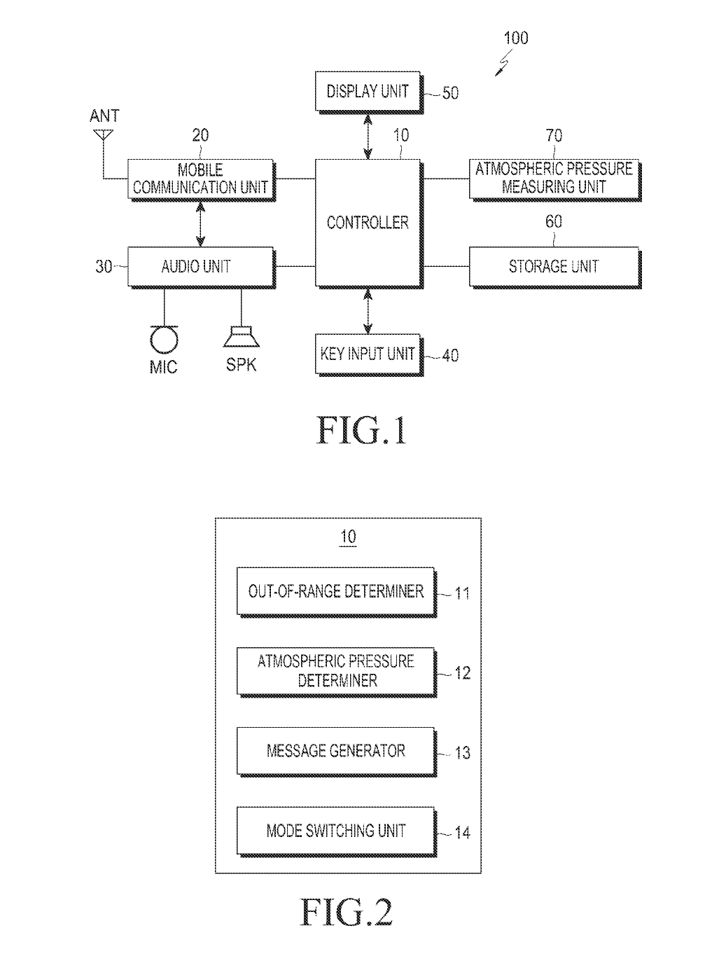

FIG. 1 is a block diagram illustrating a mobile terminal 100 according to an embodiment of the present invention.

Referring to FIG. 1, the mobile terminal 100 includes a controller 10, a mobile communication unit 20, an audio unit 30, a key input unit 40, a display unit 50, a storage unit 60, and an atmospheric pressure measuring unit 70.

The mobile communication unit 20 includes a Radio Frequency (RF) unit (not shown) and a modulator-demodulator (modem) (not shown). The RF unit includes an RF transmitter (not shown) for up-converting a frequency of a signal to be transmitted and amplifying the up-converted signal, and an RF receiver (not shown) for low-noise amplifying a received signal and down-converting a frequency of the received signal. The modem includes a transmitter (not shown) for encoding and modulating the signal to be transmitted, a receiver (not shown) for demodulating and decoding a signal received from the RF unit, and the like.

The audio unit 30 may include a coder-decoder (codec) (not shown) including a data codec and an audio codec. The data codec processes packet data and other such data, and the audio codec processes audio signals, such as voice, multimedia files, etc. The audio unit 30 converts a digital audio signal received from the modem into an analog signal through the audio codec and plays the analog signal using a speaker. The audio unit 30 converts an analog audio signal received from a microphone into a digital audio signal through the audio codec and transmits the digital audio signal to the modem. The data codec and the audio codec may be separately provided or included in the controller 10.

If the operation mode of the mobile terminal 100 is automatically switched to the airplane mode, the audio unit 30 may output information notifying a user that the mobile terminal 100 entered the airplane mode, in the form of acoustic information (e.g., a sound saying “You Have Entered Airplane Mode”).

If the operation mode of the mobile terminal 100 is semi-automatically switched to the airplane mode, the audio unit 30 may output information notifying a user that the mobile terminal 100 is going to enter the airplane mode, in the form of acoustic information (e.g., a sound saying “Would You Enter Airplane Mode?”, or “30 More Seconds. You Will Enter Airplane Mode if There Is No Selection.”)

Meanwhile, if the operation mode of the mobile terminal 100 is manually switched to the airplane mode, the audio unit 30 may output information notifying the user that the mobile terminal 100 is going to enter the airplane mode, in the form of acoustic information (e.g., a sound saying “Would You Enter Airplane Mode?”).

The key input unit 40 may include numeric/character keys for allowing a user to input numerical and text information, function keys for setting various functions, a touch pad, etc. (not shown). If the display unit 50 is implemented as a capacitive-type or resistive-type touch screen, the key input unit 40 may include a minimum number of predetermined keys (not shown), and the display unit 50 may provide a part of the key input functions of the key input unit 40.

The key input unit 40 may receive an input value from a user for switching the operation mode of the mobile terminal 100 to the airplane mode or for cancelling switching to the airplane mode before the operation mode of the mobile terminal 100 is semi-automatically/manually switched to the airplane mode.

The storage unit 60 includes a program memory and a data memory (not shown). The program memory stores programs for controlling the general operations of the mobile terminal 100. The storage unit 60 may further include Compact Flash (CF), Secure Digital (SD), Micro Secure Digital (Micro-SD), Mini Secure Digital (Mini-SD), Extreme Digital (xD), and an external memory, such as a memory stick, etc. The storage unit 60 may also include a disk, such as a Hard Disk Drive (HDD) and/or a Solid State Disk (SSD).

The storage unit 60 may store network connection information including the number of times by which the mobile communication unit 20 has disconnected from a mobile communication network, time periods for which the mobile communication unit 20 has disconnected from the mobile communication network, etc., at regular time intervals, in a separate database, under the control of the controller 10, and provides the network connection information of the mobile terminal 100 to another component (e.g., the controller 10) as necessary.

The storage unit 60 stores at least one of an atmospheric pressure measured through a barometer (not shown) included in the atmospheric pressure measuring unit 70 and a flight altitude measured through an altimeter (not shown) included in the atmospheric pressure measuring unit 70, at regular time intervals, in separate database, under the control of the controller 10, and provides atmospheric pressure information or altitude information stored in the database to another component (for example, the controller 10) as necessary.

The storage unit 60 stores information about a cabin altitude range and a flight altitude range for each aircraft model in separate database, and provides the information about the cabin altitude range and the flight altitude range for each aircraft model to another component (e.g., the controller 10) as necessary.

The storage unit 60 stores information about a cabin atmospheric pressure range and a flight atmospheric pressure range obtained by converting the information about the cabin altitude range and the flight altitude range for each aircraft model into atmospheric pressure values, respectively, in separate database, and provide the information about the cabin atmospheric pressure range and the airplane atmospheric pressure range for each aircraft model to another component (for example, the controller 10) as necessary.

The cabin altitude range is an altitude range according to the internal pressure of a cabin in which passengers are located, and the cabin altitude range is adjusted in the range of +500 to −300 ft/min by a cabin pressurization system. The Federal Aviation Administration (FAA) states that an airplane flying at an altitude above 3000 m should maintain the internal pressure of a cabin at an atmospheric pressure corresponding to an altitude of 8000 ft, and also states a cabin altitude range for each aircraft model. For example, the FAA states that a cabin altitude range of an aircraft model B-727 is 5,400 ft and a cabin altitude range of an aircraft model B-747 is 4,700 ft.

The flight altitude range represents a vertical distance from an in-flight airplane to the earth. The flight altitude range for each aircraft model may be one of altitude ranges designated by Aviation Acts (laws related to aviation operation) of individual countries. For example, Aviation Acts of Korea designate a flight altitude range of 22,000 to 28,000 ft for domestic flights and a flight altitude range of 26,000 to 42,000 ft for international flights.

The atmospheric pressure measuring unit 70 may include at least one of a barometer for measuring a pressure (not shown) and an altimeter (not shown) for measuring an altitude, and may provide an atmospheric pressure and an altitude at a current location of the mobile terminal 100. The barometer may measure an atmospheric pressure at the current location of the mobile terminal 100, and may provide the measured atmospheric pressure. The measured atmospheric pressure may be converted into an altitude value. The altimeter may measure an altitude at the current location of the mobile terminal 100, and may provide the measured altitude. The measured altitude may be converted into an atmospheric pressure value.

For example, when the atmospheric pressure measuring unit 70 includes a barometer, if the mobile terminal 100 is located in an aircraft at a place in which an atmospheric pressure is adjusted by a cabin pressurization system, the barometer may measure an atmospheric pressure in consideration of a cabin altitude range of the aircraft and provide the measured atmospheric pressure.

Meanwhile, if the mobile terminal 100 is located in an aircraft at a place in which an atmospheric pressure is not adjusted by a cabin pressurization system, the barometer may measure an atmospheric pressure in consideration of a flight altitude range of the aircraft and provide the measured atmospheric pressure.

Also, when the atmospheric pressure measuring unit 70 includes an altimeter, if the mobile terminal 100 is located in an aircraft at a place in which an atmospheric pressure is adjusted by a cabin pressurization system, the altimeter may measure an altitude in consideration of a cabin altitude range of the aircraft and provide the measured altitude.

Meanwhile, if the mobile terminal 100 is located in an aircraft at a place in which an atmospheric pressure is not adjusted by a cabin pressurization system, the altimeter may measure an altitude in consideration of a flight altitude range of the aircraft and provide the measured altitude.

The display unit 50 includes a display, such as a Liquid Crystal Display (LCD) or an Organic Light Emitting Diodes (OLED) such as Passive Mode OLED (PMOLED) or Active Mode OLED (AMOLED), and displays various data generated in the mobile terminal 100. The display unit 50 may include a capacitive-type or resistive-type touch screen (not shown), and operate as an input unit for controlling the mobile terminal 100 together with the key input unit 40.

The controller 10 controls overall operation of the mobile terminal 100, and can switch or control operations of the mobile terminal 100 according to a user command received through the key input unit 40, the display unit 50, etc.

Meanwhile, upon determining that the mobile terminal 100 is located in an aircraft based on an atmospheric pressure measured at a current location of the mobile terminal 100, through the barometer included in the atmospheric pressure measuring unit 70, and a cabin atmospheric pressure range and a flight atmospheric pressure range stored in the storage unit 60, the controller 10 switches the operation mode of the mobile terminal 100 to the airplane mode.

Also, upon determining that the mobile terminal 100 is located in an aircraft based on an altitude measured at a current location of the mobile terminal 100, through the altimeter included in the atmospheric pressure measuring unit 70, and a cabin altitude range and a flight altitude range stored in the storage unit 60, the controller 10 switches the operation mode of the mobile terminal 100 to the airplane mode.

Also, the controller 10 may receive network connection information stored in the storage unit 60 before switching the operation mode of the mobile terminal 100 to the airplane mode, and determine whether the mobile terminal 100 is out of a communication range based on the network connection information, thereby increasing reliability in determining whether the mobile terminal 100 is located in an aircraft.

A method of determining whether the mobile terminal 100 is located in an aircraft is to convert an atmospheric pressure measured at a current location of the mobile terminal 100 into an altitude value, and to determine whether the altitude value is included in one of a cabin altitude range and a flight altitude range for each aircraft model.

Also, one example according to an embodiment of the present invention includes converting a cabin altitude range and a flight altitude range for each aircraft model into atmospheric pressure values to acquire a cabin atmospheric pressure range and a flight atmospheric pressure range, respectively, and determining whether an atmospheric pressure measured at the current location of the mobile terminal 100 belongs to one of the cabin atmospheric pressure range and the flight atmospheric pressure range.

Also, according to an embodiment of the present invention, the method includes determining whether an altitude measured at the current location of the mobile terminal 100 belongs to one of a cabin altitude range and a flight altitude range for each aircraft model.

Also, according to an embodiment of the present invention, the method includes converting an altitude measured at the current location of the mobile terminal 100 into an atmospheric pressure value, and determining whether the atmospheric pressure value belongs to one of a cabin atmospheric pressure range and a flight atmospheric pressure range for each aircraft model.

According to an embodiment of the present invention, the controller 10 generates a message for notifying a user of an ability to switch the operation mode of the mobile terminal 100, and displays the message through the display unit 50 or the audio unit 30, before switching the operation mode of the mobile terminal 100 to the airplane mode. Then, the controller 10 switches the operation mode of the mobile terminal 100 to the airplane mode or cancels switching to the airplane mode according to a user command received through the key input unit 40 or the display unit 50 within a predetermined waiting time period. The message for notifying [the user to switch the operation mode of the mobile terminal 100 may be displayed through the display unit 50 in the form of a pop-up window including at least one of text, an icon, a figure, and a picture, or may be output in the form of a voice message through the audio unit 30.

Meanwhile, in FIG. 1, devices, such as a Bluetooth module, a camera module, a Wi-Fi module, an accelerometer, a proximity sensor, a geomagnetic sensor, a Digital Media Broadcasting (DMB) receiver, etc., which can be included in the mobile terminal 100, are not illustrated. However, the above-mentioned devices, and other similar devices, can be included in the mobile terminal 100 to provide their respective corresponding functions in accordance with embodiments of the present invention.

For example, an acceleration sensor, a gyroscope, etc., are used independently or together to measure a dynamic force, such as acceleration, vibration, impact, etc., applied to the mobile terminal 100 and mechanical movement of the mobile terminal 100, so that tilting information and motion information about an aircraft in which a user of the mobile terminal 100 is located are acquired based on the dynamic force and mechanical movement of the mobile terminal 100, and used as necessary.

FIG. 2 is a block diagram illustrating a controller according to an embodiment of the present invention. Referring to FIG. 2, the controller 10 includes an out-of-range determiner 11, an atmospheric pressure determiner 12, a message generator 13, and a mode switching unit 14. The following description will be given with reference to FIGS. 1 and 2.

The out-of-range determiner 11 determines an out-of-range state, such as according to whether a predetermined number of trials or more for connecting to a mobile communication network based on network connection information stored in the storage unit 60 have failed for a predetermined time period.

According to an embodiment of the present invention, if the out-of-range determiner 11 has determined that the mobile terminal 100 is out of a communication range, the atmospheric pressure determiner 12 measures an atmospheric pressure at a current location of the mobile terminal 100 through the atmospheric pressure measuring unit 70. The measured atmospheric pressure is converted into an altitude value, and a determination is performed as to whether the mobile terminal 100 is located in an aircraft based on the altitude value, based on a cabin altitude range and a flight altitude range for each aircraft model stored in the storage unit 60. According to another embodiment of the present invention, if the out-of-range determiner 11 has determined that the mobile terminal 100 is out of a communication range, the atmospheric pressure determiner 12 measures an atmospheric pressure at the current location of the mobile terminal 100 through the atmospheric pressure measuring unit 70. Then, the mobile terminal 100 determines whether the mobile terminal 100 is located in an aircraft based on the measured atmospheric pressure, and a cabin atmospheric pressure range and a flight atmospheric pressure range for each aircraft model stored in the storage unit 60.

According to another embodiment of the present invention, if the out-of-range determiner 11 has determined that the mobile terminal 100 is out of a communication range, the atmospheric pressure determiner 12 measures an altitude at the current location of the mobile terminal 100 through the atmospheric pressure measuring unit 70. Then, the mobile communication terminal 100 determines whether the mobile terminal 100 is located in an aircraft based on the measured altitude, based on a cabin altitude range and a flight altitude range for each aircraft model stored in the storage unit 60.

According to another embodiment of the present invention, if the out-of-range determiner 11 has determined that the mobile terminal 100 is out of a communication range, the atmospheric pressure determiner 12 measures an altitude at the current location of the mobile terminal 100 through the atmospheric pressure measuring unit 70. The measured altitude is converted into an atmospheric pressure value, and the mobile terminal 100 determines whether the mobile terminal 100 is located in an aircraft based on the atmospheric pressure value, based upon a cabin atmospheric pressure range and a flight atmospheric pressure range for each aircraft model stored in the storage unit 60.

The atmospheric pressure determiner 12 also starts to operate when the out-of-range determiner 11 has determined that the mobile terminal 100 is out of a communication range. In this case, it is unnecessary to monitor whether the mobile terminal 100 is in an aircraft, which leads to a reduction of unnecessary battery consumption.

Upon a determination that the mobile terminal 100 is in an aircraft, the message generator 13 may generate a message for allowing a user to switch the operation mode of the mobile terminal 100 before switching the operation mode of the mobile terminal 100 to the airplane mode.

The mode switching unit 14 switches the operation mode of the mobile terminal 100 to the airplane mode or cancels switching the operation mode to the airplane mode.

For example, if a user command is received through the key input unit 40 or the display unit 50, the mode switching unit 14 switches the operation mode of the mobile terminal 100 to the airplane mode or cancel switching to the airplane mode according to the user command.

Also, if no user command is received through the key input unit 40 or the display unit 50 for a predetermined waiting time period (for example, for 30 seconds), the mode switching unit 14 switches the operation mode of the mobile terminal 100 to the airplane mode.

Meanwhile, the above-described components are shown as different blocks to represent that they can be functionally and logically separated from each other, however, the different blocks do not necessarily mean that they should be constituted as separate devices or implemented as different codes.

Each functional unit (or a module) may signify a functional and structural combination of hardware for implementing the technological concept of the present invention and software for driving the hardware. For example, the module may signify a logical unit of a predetermined code and a hardware resource for implementing the predetermined code, and it does not necessarily mean physically connected codes or one kind of hardware.

Hereinafter, methods for switching the operation mode of the mobile terminal 100 to an airplane mode will be described with reference to FIGS. 1 to 5.

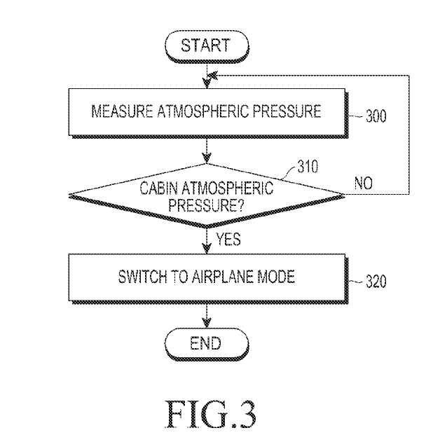

FIG. 3 is a flowchart illustrating a method for automatically switching the operation mode of the mobile terminal 100 to the airplane mode, according to an embodiment of the present invention.

Referring to FIG. 3, the controller 10 measures an atmospheric pressure at a current location of the mobile terminal 100 through the atmospheric pressure measuring unit 70, in step 300.

Also, the controller 10 measures an altitude at the current location of the mobile terminal 100 through the atmospheric pressure measuring unit 70.

Then, the controller 10 determines whether the atmospheric pressure measured through the atmospheric pressure unit 70 is a cabin atmospheric pressure, in step 310. For example, the controller 10 converts the measured atmospheric pressure into an altitude value, and then determines whether the altitude value belongs to one of a cabin altitude range and a flight altitude range for each aircraft mode stored in the storage unit 60 to thereby determine whether the mobile terminal 100 is located in an aircraft. If the atmospheric pressure measured at the current location of the mobile terminal 100 does not correspond to a cabin atmospheric pressure, the controller 10 returns to step 300, and again measures an atmospheric pressure at the current location of the mobile terminal 100.

The controller 10 may determine whether the measured atmospheric pressure belongs to one of a cabin atmospheric pressure range and a flight atmospheric pressure range stored in the storage unit 60 to thereby determine whether the mobile terminal 100 is located in an aircraft.

If an altitude has been measured at the current location of the mobile terminal 100, the controller 10 may determine whether the measured altitude belongs to one of the cabin altitude range and the flight altitude range stored in the storage unit 60 to thereby determine whether the mobile terminal 100 is located in an aircraft.

Then, upon a determination that the mobile terminal 100 is located in an aircraft, the controller 10 may switch the operation mode of the mobile terminal 100 to the airplane mode, in step 320.

Also, before switching the operation mode of the mobile terminal 100 to the airplane mode, the controller 10 may further determine whether the mobile terminal 100 has disconnected from a mobile communication network, that is, whether the mobile terminal 100 is out of a communication range, thereby increasing reliability in determining whether the mobile terminal 100 is located in an aircraft.

The method of automatically switching the operation mode of the mobile terminal 100 to the airplane mode, according to the present embodiment, reduces battery consumption of the mobile terminal 100 by automatically switching the operation mode of the mobile terminal 100 to the airplane mode when the mobile terminal 100 is located at a place such as an aircraft's cargo compartment in which a user cannot switch the operation mode of the mobile terminal 100 to the airplane mode. Accordingly, a user may use his/her mobile terminal 100 without recharging it even after a long flight.

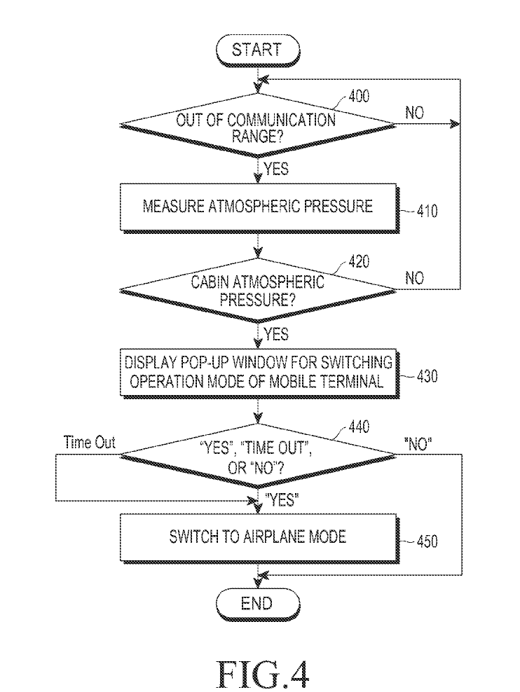

FIG. 4 is a flowchart illustrating a method for semi-automatically switching the operation mode of the mobile terminal 100 to the airplane mode, according to an embodiment of the present invention.

Referring to FIGS. 1 and 4, the controller 10 determines whether the mobile terminal 100 has disconnected from a mobile communication network (i.e., whether the mobile terminal 100 is out of a communication range), in step 400. If the mobile terminal 100 is in the communication range, the controller 10 monitors whether the mobile terminal 100 deviates from the communication range.

If the mobile terminal 100 is out of the communication range, the controller 10 measures an atmospheric pressure at a current location of the mobile terminal 100 through the atmospheric pressure measuring unit 70, in step 410.

If the mobile terminal 100 is out of the communication range, the controller 10 measures an altitude at the current location of the mobile terminal 100 through the atmospheric pressure measuring unit 70.

Then, the controller 10 determines whether the atmospheric pressure measured through the atmospheric pressure measuring unit 70 is a cabin atmospheric pressure, in step 420. For example, the controller 10 may convert the measured atmospheric pressure into an altitude value, and then determine whether the altitude value belongs to one of a cabin altitude range and a flight altitude range for each aircraft model stored in the storage unit 60 to thereby determine whether the mobile terminal 100 is located in an aircraft. If the atmospheric pressure measured at the current location of the mobile terminal 100 does not correspond to a cabin atmospheric pressure, the controller 10 returns to step 400 to monitor whether the mobile terminal 100 deviates from the communication range.

According to another example, the controller 10 may determine whether the measured atmospheric pressure belongs to one of a cabin atmospheric pressure range and a flight atmospheric pressure range stored in the storage unit 60 to determine whether the mobile terminal 100 is located in an aircraft.

According to another example, if an altitude has been measured at the current location of the mobile terminal 100, the controller 10 may determine whether the altitude belongs to one of a cabin altitude range and a flight altitude range stored in the storage unit 60 to determine whether the mobile terminal 100 is located in an aircraft.

Upon a determination that the mobile terminal 100 is located in an aircraft, the controller 10 generates a message for allowing a user to switch the operation mode of the mobile terminal 100 before switching the operation mode of the mobile terminal 100 to the airplane mode, in step 430. The controller 10 may display a message through the display unit 50 in the form of a pop-up window including at least one of text, an icon, a figure, and a picture, or may output the message in the form of a voice message through the audio unit 30.

Then, if a user command is received through the key input unit 40 or the display unit 50, the controller 10 switches the operation mode of the mobile terminal 100 to the airplane mode or cancels switching to the airplane mode according to the received user command, in step 440. For example, if a received user command is “Yes” or if no user command is received for a predetermined waiting time period (for example, for 30 seconds), the controller 10 switches the operation mode of the mobile terminal 100 to the airplane mode in step 450. However, if a received user command is “No”, the controller 10 cancels switching to the airplane mode.

The method of semi-automatically switching the operation mode of the mobile terminal 100 to the airplane mode, according to the current embodiment of the present invention, reduces battery consumption by switching the operation mode of the mobile terminal 100 to the airplane mode according to a user's selection when the mobile terminal 100 is out of a communication range and when the mobile terminal 100 is located at a place with an altitude belonging to a cabin altitude range or with an atmospheric pressure corresponding to an altitude belonging to the cabin altitude range. Accordingly, a user may use his/her mobile terminal without recharging, after deviating from an out-of-range zone. For example, by switching the operation mode of the mobile terminal 100 to the airplane mode when the mobile terminal 100 is out of a communication range and located at a mountain with a high altitude, it is possible to reduce battery consumption of the mobile terminal 100.

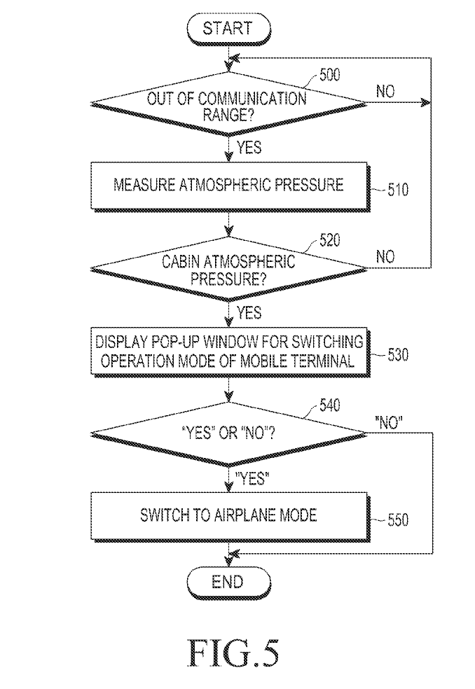

FIG. 5 is a flowchart illustrating a method of manually switching the operation mode of the mobile terminal 100 to the airplane mode, according to an embodiment of the present invention.

Referring to FIGS. 1 and 5, the controller 10 determines whether the mobile terminal 100 has disconnected from a mobile communication network (i.e., whether the mobile terminal 100 is out of a communication range), in step 500. If the mobile terminal 100 is in the communication range, the controller 10 monitors whether the mobile terminal 100 deviates from the communication range.

If the mobile terminal 100 is out of the communication range, the controller 10 may measure an atmospheric pressure at a current location of the mobile terminal 100 through the atmospheric pressure measuring unit 70, in step 510.

Also, if the mobile terminal 100 is out of the communication range, the controller 10 may measure an altitude at the current location of the mobile terminal 100 through the atmospheric pressure measuring unit 70.

Then, the controller 10 determines whether the atmospheric pressure measured through the atmospheric pressure measuring unit 70 is a cabin atmospheric pressure, in step 520. The controller 10 may convert the measured atmospheric pressure to an altitude value, and then determine whether the altitude value belongs to one of a cabin altitude range and a flight altitude range for each aircraft model stored in the storage unit 60 to determine whether the mobile terminal 100 is located in an aircraft. If the atmospheric pressure measured at the current location of the mobile terminal 100 does not correspond to a cabin atmospheric pressure, the controller 10 returns to step 500 to monitor whether the mobile terminal 100 deviates from the communication range.

For example, the controller 10 determines whether the measured atmospheric pressure belongs to one of a cabin atmospheric pressure range and a flight atmospheric pressure range stored in the storage unit 60 to determine whether the mobile terminal 100 is located in an aircraft.

According to another example, if an altitude has been measured at the current location of the mobile terminal 100, the controller 10 determines whether the measured altitude belongs to one of a cabin altitude range and a flight altitude range stored in the storage unit 60 to determine whether the mobile terminal 100 is located in an aircraft.

Then, upon a determination that the mobile terminal 100 is located in an aircraft, the controller 10 generates a message for allowing a user to switch the operation mode of the mobile terminal 100 before switching the operation mode of the mobile terminal 100 to the airplane mode. The controller 10 may display the message through the display unit 50 in the form of a pop-up window including at least one of text, an icon, a figure, and a picture, or may output the message in the form of a voice message through the audio unit 30, in step 530.

If a user command is received through the key input unit 40 or the display unit 50, the controller 10 switches the operation mode of the mobile terminal 100 to the airplane mode or cancel switching to the airplane mode according to the received user command, in step 540. For example, if the received user command is “Yes”, the controller 10 switches the operation mode of the mobile terminal 100 to the airplane mode, in step 550, and if the received user command is “No”, the controller 10 cancels switching to the airplane mode.

The method of manually switching the operation mode of the mobile terminal 100 to the airplane mode, according to the current embodiment of the present invention, reduces battery consumption by switching the operation mode of the mobile terminal 100 to the airplane mode according to a user's selection when the mobile terminal 100 is out of a communication range and when the mobile terminal 100 is located at a place with an altitude belonging to a cabin altitude range or with an atmospheric pressure belonging to a cabin atmospheric pressure range. Accordingly, a user may use his/her mobile terminal without recharging, after deviating from an out-of-range zone. For example, when the mobile terminal 100 is temporarily out of the communication range and located at a place with a high altitude, the mobile terminal 100 may switch the operation mode of the mobile terminal 100 to the airplane mode or cancel switching to the airplane mode according to a user's selection.

Hereinafter, the methods of switching the operation mode of the mobile terminal 100 to the airplane mode, according to embodiments of the present invention, will be illustrated with reference to FIGS. 1 and 6 to 8.

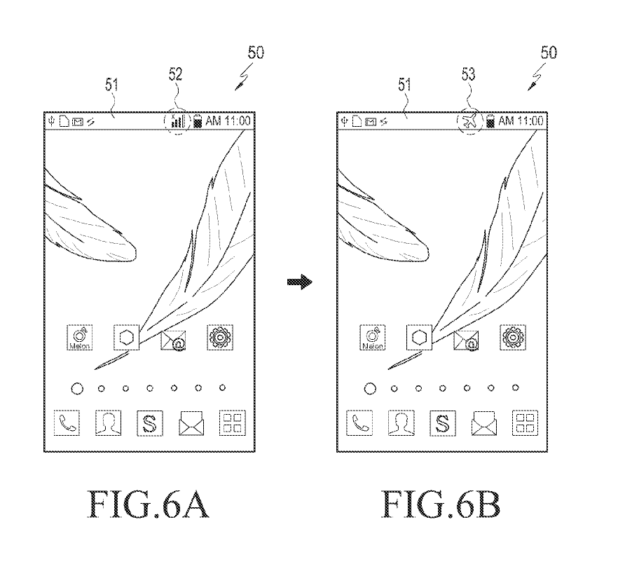

FIGS. 6A and 6B illustrate a method for automatically switching the operation mode of the mobile terminal 100 to the airplane mode, according to an embodiment of the present invention. Referring FIG. 6A, if the mobile terminal 100 deviates from a communication range, an icon 52 representing an out-of-range status is displayed in a status window 51 displayed on the top area of the display unit 50. The status window 51 and the icon 52 may be referred to as an indicator area and an indicator, respectively. Through the method of automatically switching the operation mode of the mobile terminal 100 to the airplane mode, as described in detail with reference to FIG. 3, the controller 10 determines that the mobile terminal 100 is located in an aircraft, and switches the operation mode of the mobile terminal 100 to the airplane mode. In this case, as illustrated in FIG. 6B, the controller 10 displays an icon 53 representing that the mobile terminal 100 is in the airplane mode in the status window 51 of the mobile terminal 100.

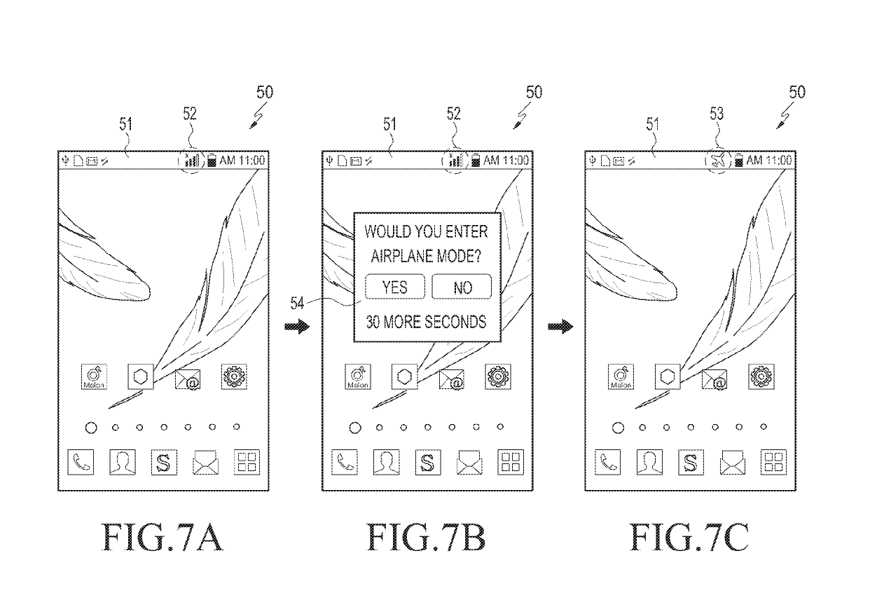

FIGS. 7A to 7C illustrate a method for semi-automatically switching the operation mode of the mobile terminal 100 to the airplane mode, according to an embodiment of the present invention.

Referring to FIG. 7A, if the mobile terminal 100 deviates from a communication range, an icon 52 representing an out-of-range status is displayed in a status window 51 of the display unit 50. Through the method of semi-automatically switching the operation mode of the mobile terminal 100 to the airplane mode, as described in detail with reference to FIG. 4, the controller 10 determines that the mobile terminal 100 is located in an aircraft, generates a message for allowing a user to select an airplane mode, and displays the message in the form of a pop-up window 54 on the display unit 50, as illustrated in FIG. 7B. Thereafter, if a user command of “Yes” is received or if no command is received for a predetermined waiting time (for example, for 30 seconds), the controller 10 switches the operation mode of the mobile terminal 100 to the airplane mode. In this case, the controller 10 displays an airplane mode icon 53 indicating that the mobile terminal 100 is in the airplane mode in the status window 51 of the mobile terminal 100, as illustrated in FIG. 7C.

Meanwhile, if a user command of “No” is received after the message is displayed, the controller 10 cancels switching to the airplane mode.

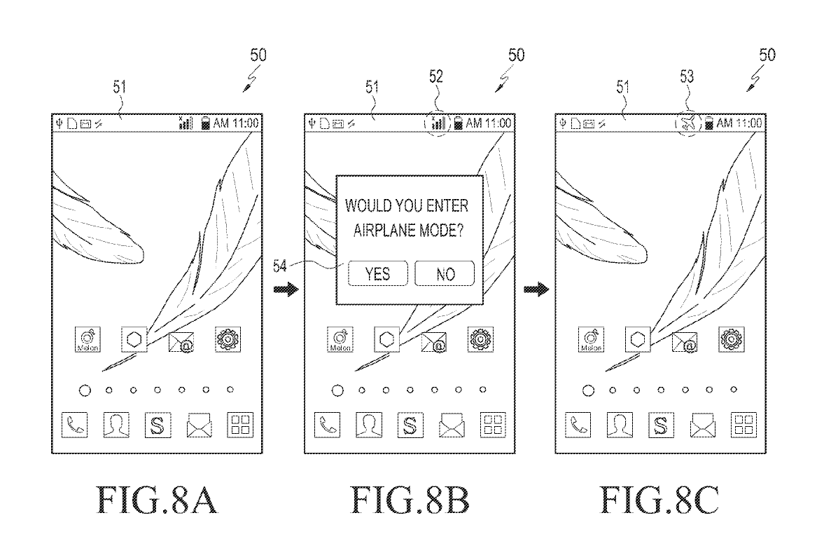

FIGS. 8A to 8C illustrate a method for manually switching the operation mode of the mobile terminal to the airplane mode, according to an embodiment of the present invention. Referring to FIG. 8A, if the mobile terminal 100 deviates from a communication range, an icon 52 representing an out-of-range status is displayed in a status window 51 of the display unit 50. Through a method of manually switching the operation mode of the mobile terminal 100 to the airplane mode, as described in detail with reference to FIG. 5, the controller 10 determines that the mobile terminal 100 is located in an aircraft, generates a message for allowing a user to select the airplane mode, and displays the message in the form of a pop-up window 54 on the display unit 50, as illustrated in FIG. 8B. Thereafter, if a user command of “Yes” is received, the controller 10 switches the operation mode of the mobile terminal 100 to the airplane mode. At this time, the controller 10 displays an icon 53 representing that the mobile terminal 100 is in the airplane mode in the status window 51 of the mobile terminal 100, as illustrated in FIG. 8C.

Meanwhile, if a user command of “No” is received after the message is displayed, the controller 10 cancels switching to the airplane mode.

As described above, through the methods and apparatus for switching the operation mode of the mobile terminal 100, according to the various embodiments of the present invention, it is possible to easily switch the operation mode of the mobile terminal to the airplane mode.

The methods of switching the operation mode of the mobile terminal according to the various embodiments of the present invention may be implemented as computer-executable programs executable by various computational devices and stored in computer-readable recording medium. The computer readable recording medium may include a program command, a data file, a data structure, or a combination thereof. The program command written to the computer readable recording medium may be specially designed and configured or may be already known to those skilled in the field of computer software. Examples of the computer readable recording medium include magnetic storage media (e.g., hard disks, floppy disks, and magnetic taps), optical recording media (e.g., Compact Disc (CD)-Read Only Memories (ROMs) and Digital Versatile Discs (DVDs)), magneto-optical storage media (e.g., floptical disks), and hardware devices (e.g., ROMs, Random-Access Memories (RAMs), Phase-change Random-Access Memories (PRAMs), Resistive Random-Access Memories (RRAMs), Ferroelectric Random-Access Memories (FRAMs), and flash memories) configured to store and execute program commands. Program commands may include, for example, a high-level language code that can be executed by a computer using an interpreter, as well as a machine language code made by a complier. The hardware devices may be configured to be operated by one or more software modules to implement the present disclosure, and vice versa.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. A method for switching an operation mode of a mobile terminal, comprising:
measuring an atmospheric pressure at a current location of the mobile terminal;
determining whether the measured atmospheric pressure is a cabin atmospheric pressure; and
setting the operation mode of the mobile terminal according to the determination.

2. The method of claim 1, further comprising determining whether to set the operation mode of the mobile terminal to an airplane mode according to whether the measured atmospheric pressure is the cabin atmospheric pressure.

3. The method of claim 1, further comprising determining whether the mobile terminal is out of a communication range, wherein the operation mode of the mobile terminal is switched to the airplane mode if the mobile terminal is out of a communication range and the measured atmospheric pressure is the cabin atmospheric pressure.

4. The method of claim 3, wherein the atmospheric pressure at the current location of the mobile terminal is measured by a barometer included in the mobile terminal.

5. The method of claim 4, wherein determining whether the measured atmospheric pressure is the cabin atmospheric pressure comprises converting the measured atmospheric pressure into an altitude value, and determining whether the altitude value is included within at least one of a cabin altitude range and a flight altitude range for an aircraft.

6. The method of claim 4, wherein determining whether the measured atmospheric pressure is the cabin atmospheric pressure comprises converting the cabin altitude range and the flight altitude range for the aircraft into a cabin atmospheric pressure range and a flight atmospheric pressure range, and determining whether the measured atmospheric pressure is included within at least one of the cabin atmospheric pressure range and the flight atmospheric pressure range.

7. The method of claim 3, wherein the measured atmospheric pressure is acquired by converting an altitude value measured by an altimeter into an atmospheric pressure.

8. The method of claim 7, wherein determining whether the measured atmospheric pressure is the cabin atmospheric pressure comprises determining whether the measured altitude value is included within at least one of a cabin altitude range and a flight altitude range for an aircraft.

9. A method for switching an operation mode of a mobile terminal, comprising:
measuring an atmospheric pressure at a current location of the mobile terminal;
determining whether the measured atmospheric pressure is a cabin atmospheric pressure;
displaying a pop-up window for allowing a user to switch the operation mode of the mobile terminal if the measured atmospheric pressure is the cabin atmospheric pressure;
determining whether to set the operation mode of the mobile terminal to an airplane mode according to whether a user command for switching the operation mode of the mobile terminal to the airplane mode is received through the pop-up window; and
setting the operation mode of the mobile terminal according to the determination.

10. The method of claim 9, further comprising determining whether the mobile terminal is out of a communication range,
wherein the operation mode of the mobile terminal is switched to the airplane mode if the mobile terminal is out of a communication range and the measured atmospheric pressure is the cabin atmospheric pressure.

11. The method of claim 9, further comprising switching the operation mode of the mobile terminal to the airplane mode if no user command is received for a predetermined waiting time period.

12. An apparatus for switching an operation mode of a mobile terminal, comprising:
an atmospheric pressure measuring unit measuring an atmospheric pressure at a current location of the mobile terminal; and
a controller determining whether the measured atmospheric pressure is a cabin atmospheric pressure, and setting the operation mode of the mobile terminal according to the determination.

13. The apparatus of claim 12, wherein the controller determining whether to switch the operation mode of the mobile terminal to an airplane mode according to whether the measured atmospheric pressure is a cabin atmospheric pressure.

14. The apparatus of claim 13, wherein the controller determines whether the mobile terminal is out of a communication range, and switches the operation mode of the mobile terminal to the airplane mode if the mobile terminal is out of a communication range and the measured atmospheric pressure is the cabin atmospheric pressure.

15. The apparatus of claim 13, wherein the atmospheric pressure measuring unit comprises a barometer.

16. The apparatus of claim 14, wherein the atmospheric pressure measuring unit comprises an altimeter, and converts an altitude value measured by the altimeter into an atmospheric pressure value.

17. The apparatus of claim 14, wherein the controller displays a pop-up window for allowing a user to switch the operation mode of the mobile terminal before switching the operation mode of the mobile terminal to the airplane mode, and switches the operation mode of the mobile terminal to the airplane mode if a user command for switching the operation mode of the mobile terminal to the airplane mode is received through the pop-up window or if no user command is received for a predetermined waiting time period.
